(19) United States
(12) Patent Application Publication
(10) Pub. No.: US 2025/0264886 A1
(43) Pub. Date: Aug. 21, 2025

(54) MARKER SYSTEM AND CONTROL METHOD

(71) Applicant: AICHI STEEL CORPORATION, Tokai-shi (JP)

(72) Inventors: Takayuki ANDO, Tokai-shi (JP); Takayuki NUMANO, Tokai-shi (JP); Kazuo URAKAWA, Tokai-shi (JP)

(73) Assignee: AICHI STEEL CORPORATION, Tokai-shi (JP)

(21) Appl. No.: 19/043,582

(22) Filed: Feb. 3, 2025

(30) Foreign Application Priority Data
Feb. 15, 2024 (JP) 2024-021396

(51) Int. Cl. G05D 1/646; G05D 1/244; G05D 107/13; G05D 109/10

(52) U.S. Cl. CPC G05D 1/646; G05D 1/244; G05D 2107/13; G05D 2109/10

(57) ABSTRACT

A marker system relatively easily ensuring magnetic marker detection reliability is provided. In a marker system where magnetic markers are arranged as spaced along a path where a vehicle travels, in a combination of two magnetic markers adjacent to each other in a lateral direction and laid on a main road and a side road, respectively, the combination has a combination of different magnetic polarities when a space distance in the lateral direction is equal to or shorter than 0.3 meters, and the combination has a combination of same magnetic polarities when the space distance in the lateral direction exceeds 0.3 meters.

### CROSS-REFERENCE TO RELATED APPLICATION

The present application claims priority to Japanese application number 2024-021396 filed in the Japanese Patent Office on Feb. 15, 2024, the entire contents of which are incorporated herein by reference.

### BACKGROUND OF THE INVENTION

The present invention relates to a marker system in which magnetic markers are arranged on a traveling road so as to be detectable by a vehicle while traveling, and a vehicle control system.

Conventionally, a marker system in which magnetic markers are arranged along a traveling road so as to be detectable by a vehicle has been known (for example, refer to Japanese Unexamined Patent Application Publication No. 2017-199247). This marker system is targeted, for example, for a vehicle including a magnetic sensor unit including a detection area elongated in a vehicle-width direction. The vehicle detects a magnetic marker while traveling, and also measures a lateral deviation with respect to the detected magnetic marker. In the marker system, for example, a steered wheel is controlled so that the lateral deviation with respect to the magnetic marker is brought closer to zero, thereby achieving vehicle's automatic traveling along the traveling road.

### SUMMARY OF THE INVENTION

However, the conventional marker system has the following problem. That is, for example, in a branch road or a merge road that runs oblique to a main road, there is a possibility that a magnetic marker arranged on the main road and a magnetic marker arranged on the branch road or the merge road may be laterally aligned and, due to magnetic mutual interference between adjacent magnetic markers, there is a possibility that processing load for reliably detecting magnetic markers increases and the processing load for vehicle control also increases.

The present invention was made in view of the conventional problem described above, and is to provide a marker system that can relatively easily ensure magnetic marker detection reliability and a control method for achieving highly-accurate vehicle control.

One aspect of the present invention is directed to a marker system comprising a plurality of magnetic markers arranged as spaced along a plurality of paths where a vehicle travels, wherein
in a combination of two magnetic markers of the plurality of magnetic markers laid on different paths of the plurality of paths and adjacent to each other in a lateral direction orthogonal to a path direction, a combination of magnetic polarities of the two magnetic markers varies in accordance with a distance between the two magnetic markers, and
i) while the combination of the magnetic polarities of the two magnetic markers is a combination of different magnetic polarities when the distance between the two magnetic markers is equal to or shorter than the predetermined threshold value, the combination of the magnetic polarities of the two magnetic markers is a combination of same magnetic polarities when the distance between the two magnetic markers exceeds the predetermined threshold value, or
ii) while the combination of the magnetic polarities of the two magnetic markers is the combination of different magnetic polarities when the distance between the two magnetic markers is below the predetermined threshold value, the combination of the magnetic polarities of the two magnetic markers is the combination of same magnetic polarities when the distance between the two magnetic markers is equal to or longer than the predetermined value.

The marker system according to the present invention has one technical feature in the combination of magnetic polarities of the two magnetic markers adjacent to each other and laid on different paths. In the above-described two magnetic markers, the combination of magnetic polarities varies in accordance with whether the distance between the two magnetic markers is equal to or shorter than or below the predetermined threshold value. i) While the combination of the magnetic polarities of the two magnetic markers is the combination of different magnetic polarities when the distance between the two magnetic markers is equal to or shorter than the predetermined threshold value, the combination of the magnetic polarities of the two magnetic markers is the combination of same magnetic polarities when the distance between the two magnetic markers exceeds the predetermined threshold value, or ii) while the combination of the magnetic polarities of the two magnetic markers is the combination of different magnetic polarities when the distance between the two magnetic markers is below the predetermined threshold value, the combination of the magnetic polarities of the two magnetic markers is the combination of same magnetic polarities when the distance between the two magnetic markers is equal to or longer than the predetermined value.

As the two magnetic markers adjacent to each other approach closer to each other, the possibility of occurrence of magnetic interference increases. If the magnetic polarities of these two magnetic markers are the same, the magnetic distribution becomes broad due to magnetic interference acted from two magnetic markers, and a possibility occurs in which peaks supposed to occur directly above magnetic markers are difficult to detect. On the other hand, if the magnetic polarities of the two magnetic markers adjacent to each other in the width direction of the path are different, detection of peaks in the magnetic distribution are easy even if magnetic interference occurs, and each magnetic marker can be detected with high reliability. If the magnetic marker can be detected with high reliability, it is possible to improve stability of vehicle control using the magnetic markers.

### BRIEF DESCRIPTION OF DRAWINGS

FIG. 1 is a descriptive diagram of a marker system in a first embodiment;

FIG. 2 is a perspective view of a magnetic marker in the first embodiment;

FIG. 3 is a configuration diagram of a vehicle in the first embodiment;

FIG. 4 is a graph of an approximate curve representing a distribution of magnetic measurement values in a vehicle-width direction derived from one magnetic marker in the first embodiment;

FIG. 5 is a descriptive diagram of a mode of laying magnetic markers at a branching section in the first embodiment;

FIG. 6 is a descriptive diagram of a mode of laying magnetic markers at a merging section in the first embodiment;

FIG. 7 is a first graph of an approximate curve representing a distribution of magnetic measurement values in the vehicle-width direction derived from laterally-aligned two magnetic markers with same magnetic polarities in the first embodiment;

FIG. 8 is a second graph of an approximate curve representing a distribution of magnetic measurement values in the vehicle-width direction derived from laterally-aligned two magnetic markers with same magnetic polarities in the first embodiment;

FIG. 9 is a graph of an approximate curve representing a distribution of magnetic measurement values in the vehicle-width direction derived from laterally-aligned two magnetic markers with different magnetic polarities in the first embodiment;

FIG. 10 is a diagram describing a relation between a space between laterally-aligned two magnetic markers and a combination of magnetic polarities in the first embodiment;

FIG. 11 is a flow diagram depicting a flow of vehicle traveling control in the first embodiment;

FIG. 12 is a descriptive diagram depicting a movement of the vehicle passing through the branching section in the first embodiment;

FIG. 13 is a descriptive diagram depicting a movement of the vehicle going to a branch road in the branching section in the first embodiment;

FIG. 14 is a descriptive diagram depicting a movement of the vehicle passing through the merging section while traveling a main road in the first embodiment;

FIG. 15 is a descriptive diagram depicting a movement of the vehicle merging to the main road in the merging section in the first embodiment;

FIG. 16 is a descriptive diagram depicting the structure of a traveling road in a second embodiment;

FIG. 17 is a perspective view of a magnetic marker with an RFID tag attached thereto in in the second embodiment;

FIG. 18 is a descriptive diagram of a mode of laying magnetic markers in the branching section in a third embodiment;

FIG. 19 is a descriptive diagram of a mode of laying magnetic markers in the merging section in the third embodiment; and

FIG. 20 is a flow diagram depicting a flow of vehicle traveling control in the third embodiment.

### DETAILED DESCRIPTION OF THE INVENTION

Modes of the present invention are specifically described by using the following embodiments.

### First Embodiment

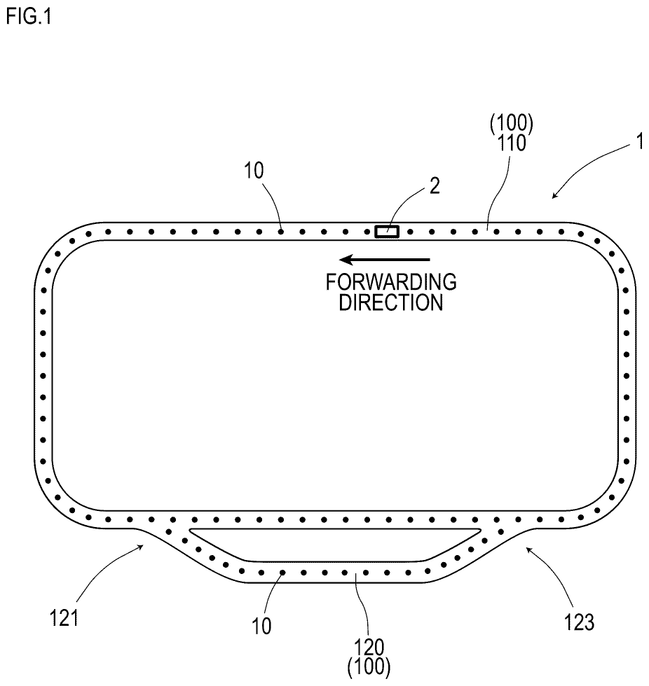

The present embodiment is an example regarding marker system 1 in which magnetic markers 10 are arrayed along a plurality of paths, and a vehicle control method. Details of this are described by using FIG. 1 to FIG. 15.

Marker system 1 (FIG. 1) of the present embodiment is, for example, a system of magnetic markers 10 laid in traveling road 100 of vehicle 2. Traveling road 100 is, for example, a traveling road configuring a BRT (bus rapid transit). On traveling road 100 to which marker system 1 is applied, vehicle 2 (bus vehicle) travels automatically as detecting magnetic markers 10. Note that in FIG. 1, not all magnetic markers 10 arrayed along traveling road 100 are depicted and they are partially omitted in the drawing.

Traveling road 100 is, for example, a one-way circular traveling road having a width of 3 meters. In traveling road 100, magnetic markers 10 are laid as spaced in a forwarding direction. The present example is an example in which the space between magnetic markers 10 is set at 2 meters. Marker system 1 is used for vehicle 2 to circulate circular traveling road 100. Traveling road 100 has a section where side road 120 is provided to main road 110. Traveling road 100 forming main road 110 and side road 120 forms one example of a plurality of paths where vehicle 2 travels. Side road 120 forms one example of a path branching from a path forming main road 110 and one example of a path merging into a path forming main road 110.

In traveling road 100 exemplarily depicted in FIG. 1, there are two types of traveling route of vehicle 2. A first traveling route is a traveling route of circulating over main road 110 not entering side road 120. A second traveling route is a traveling route of circulating over main road 110 via side road 120. Vehicle 2 traveling the first traveling route is controlled so as to go straight to pass through branching section 121 and not to go to side road 120. Vehicle 2 traveling the second traveling route is controlled so as to branch to side road 120 in branching section 121 and then merge to main road 110 in merging section 123.

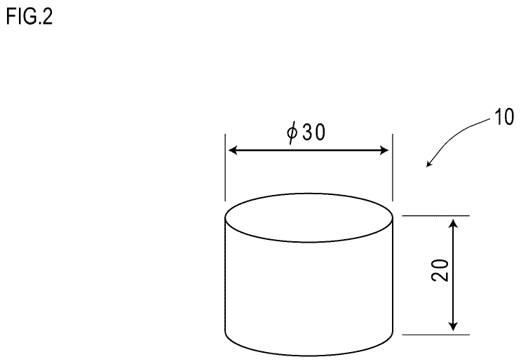

Magnetic marker 10 (FIG. 2) is a columnar-shaped magnet having a diameter of 30 millimeters and a height of 20 millimeters. Columnar-shaped magnetic marker 10 has one end face forming the N pole and the other end face forming the S pole. All magnetic markers 10 on main road 110 are buried so as to take an attitude with the N-pole end face facing upward. Magnetic markers 10 on main road 110 are each detected on a vehicle 2 side as an N-pole magnet. Although details will be described further below, magnetic markers 10 on side road 120 except part of magnetic markers 10 in branching section 121 and merging section 123 are buried so as to take an attitude with the N-pole end face facing upward. In the following description, a magnetic marker with the N pole facing upward is denoted as 10N and a magnetic marker with the S pole facing upward is denoted as 10S.

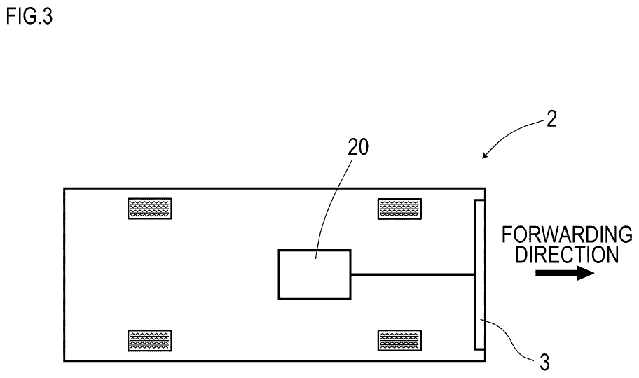

Vehicle 2 (FIG. 3) of the present embodiment is a bus vehicle having a length of 8 meters and a width of 2.3 meters. Vehicle 2 has operating systems such as a steering wheel, accelerator, and brake. Vehicle 2 includes a plurality of actuators (omitted in the drawing) for driving these operating systems and control unit 20 for controlling these actuators. Vehicle 2 can manually travel by a driver and also can travel automatically under control by control unit 20.

Vehicle 2 is configured to be able to travel automatically by using magnetic markers 10 laid along traveling road 100. Vehicle 2 includes magnetic sensor module 3 for detecting magnetic marker 10. Magnetic sensor module 3 is attached to a front portion of vehicle 2. Magnetic sensor module 3 performs process for detecting magnetic marker 10 in response to control by control unit 20 (marker detection process).

Magnetic sensor module 3 is one example of a magnetic detection circuit including a magnetic detection area elongated in the vehicle-width direction. Although not depicted in the drawing, magnetic sensor module 3 is a sensor unit including a plurality of magnetic sensors and a processing circuit that performs arithmetic process. In magnetic sensor module 3, the plurality of magnetic sensors (omitted in the drawing) are attached to a rod-shaped frame as spaced. Magnetic sensor module 3 is attached to vehicle 2 so that its longitudinal direction is along the vehicle-width direction. The length of rod-shaped magnetic sensor module 3 is close to the length of the vehicle width of vehicle 2. Magnetic sensor module 3 has a magnetic detection area elongated in the vehicle-width direction. According to magnetic sensor module 3, it is possible to detect magnetic marker 10 with high reliability irrespective of the lateral deviation of vehicle 2 in traveling road 100.

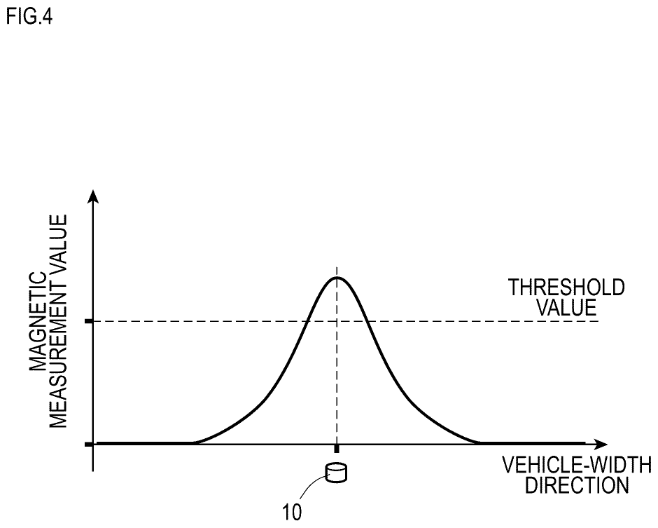

Each magnetic sensor of magnetic sensor module 3 is incorporated so as to be able to measure the magnitude of magnetism acting in a vertical direction. When magnetic sensor module 3 is positioned directly above magnetic marker 10, a distribution of magnetic measurement values by a plurality of magnetic sensors arrayed in the vehicle-width direction is, for example, as depicted in FIG. 4. Note that the drawing depicts the magnetic measurement values of each magnetic sensor by approximation by a curve. The horizontal axis in the drawing indicates the vehicle-width direction. As in the drawing, when magnetic sensor module 3 is positioned directly above magnetic marker 10, the magnetic distribution has a mountain shape with a peak value directly above magnetic marker 10.

The processing circuit of magnetic sensor module 3 applies marker detection process to the distribution formed by the magnetic measurement values of each magnetic sensor. In the marker detection process, when there is one peak exceeding a threshold value, for example, in an approximate curve in FIG. 4, it is determined that one magnetic marker 10 has been detected.

In the marker detection process, in addition to whether magnetic marker 10 has been detected, the magnetic polarity of detected magnetic marker 10 is determined, and a lateral deviation of vehicle 2 with respect to detected magnetic marker 10 is measured. For example, as in the example of FIG. 4, each magnetic sensor of magnetic sensor module 3 is configured to output a positive magnetic measurement value in accordance with magnetism acted from N-pole magnetic marker 10N and output a negative magnetic measurement value in accordance with magnetism acted from S-pole magnetic marker 10S. In the marker detection process, in accordance with the sign of the peak value when magnetic marker 10 is detected, the magnetic polarity of magnetic marker 10 is determined. Also, in the marker detection process, by identifying the position of the peak value in the vehicle-width direction, the lateral deviation of the vehicle with respect to magnetic marker 10 is identified (measured).

On performing the marker detection process, magnetic sensor module 3 outputs the process result. The process result includes information on whether magnetic marker 10 has been detected. Furthermore, the process result in the case in which magnetic marker 10 has been detected includes information on the magnetic polarity of detected magnetic marker 10 and information on the lateral deviation with respect to magnetic marker 10.

Note that, as described above, magnetic sensor module 3 has the magnetic detection area elongated in the vehicle-width direction. When a plurality of magnetic markers 10 are provided to be aligned in the vehicle-width direction, there is a possibility that the plurality of magnetic markers 10 are included in the magnetic detection area of magnetic sensor module 3. Magnetic sensor module 3 is configured to be able to output the magnetic polarity and the lateral deviation for each of the plurality of magnetic markers 10 belonging to the magnetic detection area.

Marker system 1 of the present embodiment has a technical feature in the laying mode of magnetic markers 10 in branching section 121 and merging section 123. The control method for vehicle 2 of the present embodiment has a technical feature in branching control from main road 110 to side road 120 and merging control from side road 120 to main road 110. Branching control and merging control of the present embodiment is control using the laying mode of magnetic markers 10 in branching section 121 or merging section 123.

### (Laying Modes of Magnetic Markers)

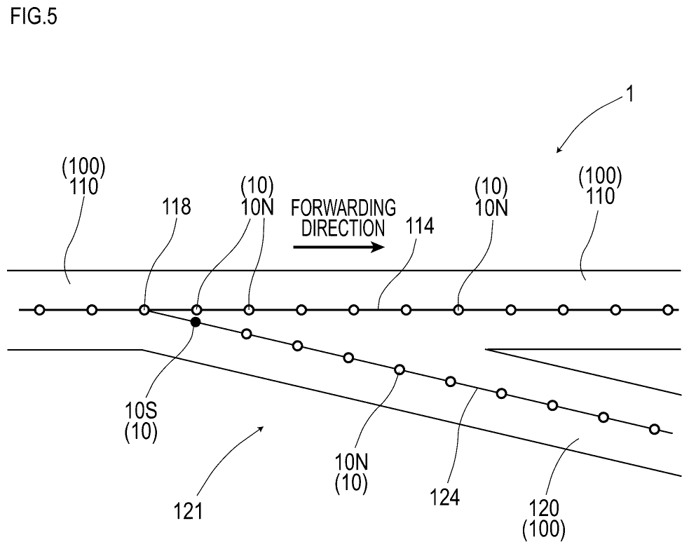

The laying mode of magnetic markers 10 in branching section 121 from main road 110 to side road 120 is a mode depicted in FIG. 5. In branching section 121, marker array line 124 where magnetic markers 10 are arrayed on side road 120 is obliquely branched from marker array line 114 where magnetic markers 10 are arrayed on main road 110. In branching section 121, a space between magnetic markers 10 on main road 110 and magnetic markers 10 on side road 120 in a lateral direction gradually expands toward the forwarding direction of traveling road 100. Here, the lateral direction means a direction substantially orthogonal to a path direction of main road 110 and side road 120 forming one example of a plurality of paths.

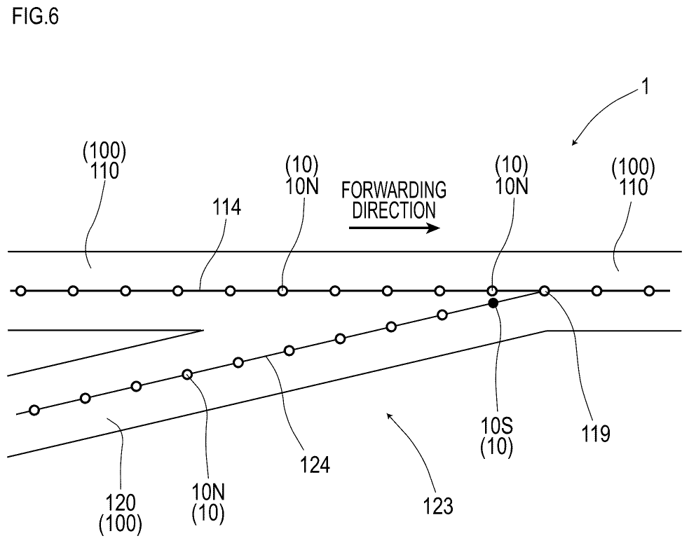

The laying mode of magnetic markers 10 in merging section 123 from side road 120 to main road 110 is a mode depicted in FIG. 6. In merging section 123, marker array line 124 on side road 120 is obliquely connected to marker array line 114 on main road 110. In merging section 123, the space between magnetic markers 10 on main road 110 and magnetic markers 10 on side road 120 in the lateral direction gradually reduces toward the forwarding direction of traveling road 100.

In branching section 121 and merging section 123, the space between two magnetic markers 10 aligned in the lateral direction (distance between laterally-aligned magnetic markers 10) is shorter as the space is closer to branching point 118 or merging point 119 between marker array line 114 on main road 110 and marker array line 124 on side road 120.

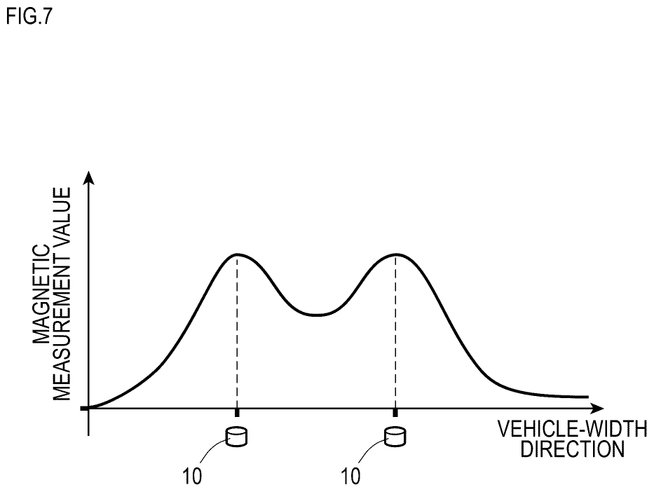

Here, if the space between laterally-aligned two magnetic markers 10 is ensured to some extent, a distribution exemplarily depicted in FIG. 7 is acquired as the distribution of magnetic measurement values in the vehicle-width direction by magnetic sensor module 3. With the magnetic distribution exemplarily depicted in this drawing, it is possible to distinguish the peak corresponding to each magnetic marker 10 and detect each magnetic marker 10.

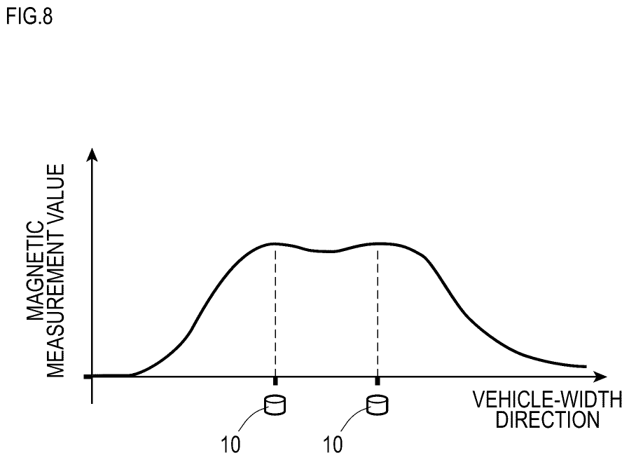

On the other hand, when the space between laterally-aligned two magnetic markers 10 is too narrow, as exemplarily depicted in FIG. 8, the degree of difficulty of detection the peak corresponding to each magnetic marker 10 increases, because magnetic distributions derived from each magnetic marker 10 overlap to become integrated. In the case of the magnetic distribution exemplarily depicted in this drawing, while the presence of a magnetism generation source can be estimated, the degree of difficulty of detection by distinguishing each magnetic marker 10 increases.

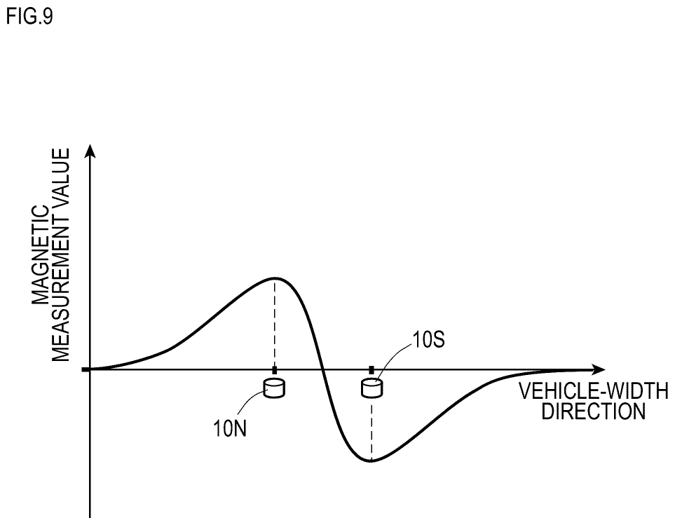

When the space between laterally-aligned two magnetic markers 10 is too narrow, a combination of different magnetic polarities is preferably adopted. In this case, as exemplarily depicted as the distribution of magnetic measurement values in FIG. 9, a positive peak value appears correspondingly to N-pole magnetic marker 10N, and a negative peak value appears correspondingly to S-pole magnetic marker 10S. In this manner, with the combination of magnetic markers 10N and 10S with different magnetic polarities, it is possible to relatively easily distinguish and detect each magnetic marker 10 even if the space between magnetic markers 10 adjacent to each other in the lateral direction is similar to that of FIG. 8.

The inventors have acquired the following findings through verification experiments and simulations. That is, if the space between magnetic markers 10 adjacent to each other in the lateral direction exceeds 0.3 meters, it is possible to easily distinguish and detect each magnetic marker 10 even with a combination of same magnetic polarities. On the other hand, if the space between magnetic markers 10 adjacent to each other in the lateral direction equal to or shorter than 0.3 meters, in the case of the combination of same magnetic polarities, process load for distinguish and detect each magnetic marker 10 increases.

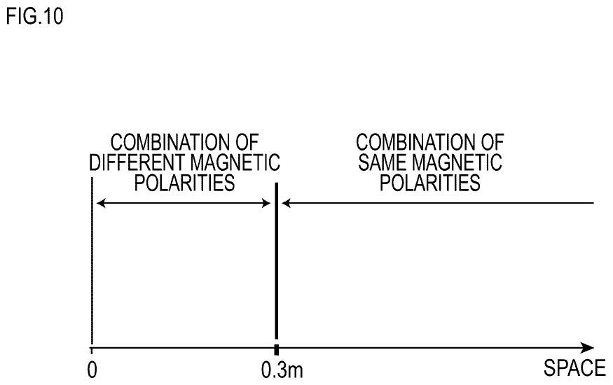

To address this, in the present embodiment, combinations of magnetic polarities of two magnetic markers are set as in FIG. 10 in accordance with the space in the lateral direction. The combination of different magnetic polarities is adopted when the space between two magnetic markers 10 is equal to or shorter than 0.3 meters, and the combination of same magnetic polarities is adopted when the space between two magnetic markers 10 exceeds 0.3 meters.

In the present embodiment, 0.3 meters is exemplarily set as one example of a predetermined threshold value for switching whether the combination of magnetic polarities of laterally-aligned two magnetic markers 10 is set as the combination of same magnetic polarities and the combination of different magnetic polarities. The predetermined threshold value is preferably changed as appropriate in consideration of detection performance of magnetic sensor module 3, magnetic characteristics of magnetic marker 10, an algorithm for detecting magnetic marker 10, and so forth.

In the present embodiment, in branching section 121 and merging section 123, two magnetic markers 10 are provided to be laterally aligned. As described above, in branching section 121, the space between laterally-aligned two magnetic markers 10 gradually expands by taking branching point 118 as a starting point. In branching section 121, the space between magnetic marker 10 on main road 110 and magnetic marker 10 on side road 120 is equal to or shorter than 0.3 meters at a position immediately after passing through branching point 118 between marker array line 114 on main road 110 and marker array line 124 on side road 120. Thus, in branching section 121, S-pole magnetic marker 10S is laid at a position closest to branching point 118 on marker array line 124 on side road 120.

In merging section 123, as described above, the space between laterally-aligned two magnetic markers 10 gradually becomes narrow toward merging point 119. In merging section 123, the space between magnetic marker 10 on main road 110 and magnetic marker 10 on side road 120 is equal to or shorter than 0.3 meters at a position immediately before merging point 119 between marker array line 114 on main road 110 and marker array line 124 on side road 120. Thus, in merging section 123, S-pole magnetic marker 10S is laid at a position immediately before merging point 119 on marker array line 124 on side road 120.

### (Branching Control and Merging Control)

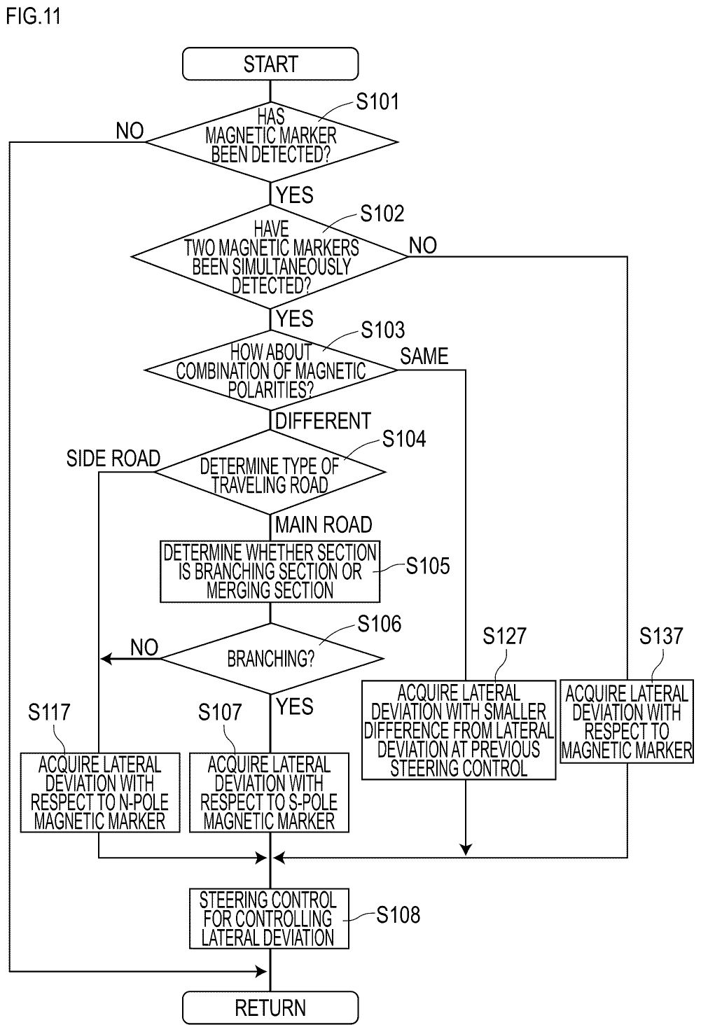

Next, branching control and merging control, which are a method of controlling vehicle 2, are described. Branching control is a control method using the laying mode (refer to FIG. 5) of magnetic markers 10 in branching section 121. Merging control is a control method using the laying mode (refer to FIG. 6) of magnetic markers 10 in merging section 123. Branching control and merging control are described with reference to a flow diagram of FIG. 11.

While vehicle 2 is traveling road 100, control unit 20 controls magnetic sensor module 3 so as to repeatedly perform marker detection process. The marker detection process is the process of, as described above, making an attempt of detecting magnetic marker 10, while performing a determination of the magnetic polarity of detected magnetic marker 10 and a measurement of the lateral deviation of vehicle 2 with respect to magnetic marker 10.

When acquiring the process result including the indication that magnetic marker 10 has been detected (S101: YES), control unit 20 first determines whether two magnetic markers 10 have been simultaneously detected (S102). In the case of not simultaneous detection of two magnetic markers 10 but single detection of one magnetic marker 10 (S102: NO), control unit 20 acquires the lateral deviation with respect to magnetic marker 10 from the process result of the marker detection process (S137). Vehicle 2 is subjected to steering control by taking the lateral deviation with respect to magnetic marker 10 as a controlled variable (S108).

If simultaneous detection of two magnetic markers 10 is determined at step S102 described above (S102: YES), control unit 20 determines the combination of magnetic polarities of detected two magnetic markers 10 (S103). Note that the process result by magnetic sensor module 3 in the case in which two magnetic markers 10 have been simultaneously detected includes information about the magnetic polarity of each magnetic marker 10 and two lateral deviations with respect to respective magnetic markers 10.

Here, as described above, in the laying mode of magnetic markers 10 of the present embodiment, among magnetic markers 10 on side road 120, S-pole magnetic marker 10S is laid at the position closest to branching point 118 or merging point 119. The other magnetic markers 10 on side road 120 and all magnetic markers 10 on main road 110 are N-pole magnetic markers 10N. On the vehicle 2 side, in accordance with simultaneous detection of any S-pole magnetic marker 10S on side road 120 and any of laterally-aligned N-pole magnetic markers 10N on main road 110, arrival at branching section 121 (branching point 118) or merging section 123 (merging point 119) can be determined.

Note that when the vehicle enters merging section 123, prior to simultaneous detection of two magnetic markers 10 with different magnetic polarities, simultaneous detection of two magnetic markers 10 with same magnetic polarities occurs. When simultaneous detection of two magnetic markers 10 with different magnetic polarities occurs subsequently to simultaneous detection of two magnetic markers 10 with same magnetic polarities, arrival at merging section 123 can be determined. On the other hand, when simultaneous detection of two magnetic markers 10 with different magnetic polarities occurs but simultaneous detection of two magnetic markers 10 with same magnetic polarities has not occurred previously, arrival at branching section 121 can be determined.

When the magnetic polarities of two magnetic markers 10 simultaneously detected are the same (S102: YES→S103: same), control unit 20 acquires, among two lateral deviations with respect to each magnetic marker 10, the lateral deviation with a smaller difference from the controlled variable at the time of the immediately-previous magnetic marker detection (the controlled variable is the lateral deviation applied to the previous steering control) (S127). Selecting the lateral deviation as the controlled variable of steering control corresponds to selecting magnetic marker 10 as a target to be followed. For example, when vehicle 2 is traveling main road 110, the lateral deviation with respect to magnetic marker 10 on main road 110 is acquired at step S127. For example, when vehicle 2 is traveling side road 120, the lateral deviation with respect to magnetic marker 10 on side road 120 is acquired at step S127. With this, vehicle 2 is subjected to steering control so as to travel by maintaining traveling road 100 where vehicle 2 is now traveling (S108).

On the other hand, at step S103 described above, when the combination of magnetic polarities of two magnetic markers 10 simultaneously detected is the combination of different magnetic polarities (S103: different), control unit 20 determines whether the type of traveling road where vehicle 2 is now traveling is main road 110 or side road 120 (S104). Control unit 20 identifies the magnetic polarity of magnetic marker 10 regarding the lateral deviation with the smaller difference from the controlled variable at the time of the immediately-previous magnetic marker detection (the controlled variable is the lateral deviation applied to the previous steering control) of two lateral deviations with respect to two magnetic markers 10N and 10S simultaneously detected. When the lateral deviation is the lateral deviation with respect to N-pole magnetic marker 10N on main road 110, the type of traveling road 100 where the vehicle is now traveling can be determined as main road 110. On the other hand, when the lateral deviation with the smaller difference from the controlled variable at the time of the immediately-previous magnetic marker detection (the controlled variable is the lateral deviation applied to the previous steering control) is the lateral deviation with respect to S-pole magnetic marker 10S, the type of traveling road 100 where the vehicle is now traveling can be determined as side road 120.

When traveling side road 120 is determined at step S104 described above (S104: side road), control unit 20 can immediately determine that laterally-aligned two magnetic markers 10 determined as having different magnetic polarities at step S103 described above are laid on merging section 123. In this case, control unit 20 acquires the lateral deviation with respect to N-pole magnetic marker 10N on main road 110 among two lateral deviations with respect to laterally-aligned two magnetic markers 10 with different magnetic polarities (S117). Then, by applying the lateral deviation with respect to N-pole magnetic marker 10N on main road 110 to steering control, merging control for merging from side road 120 to main road 110 starts (S108).

On the other hand, when traveling main road 110 is determined at step S104 described above (S104: main road), control unit 20 determines whether the vehicle is in branching section 121 or merging section 123 (S105). As described above, it is possible to determine whether the vehicle is in branching section 121 or merging section 123 in accordance with whether simultaneous detection of two magnetic markers 10 with same magnetic polarities has occurred prior to simultaneous detection of two magnetic markers 10 with different magnetic polarities.

Next, control unit 20 makes a determination as to whether or not to branch (S106). For example, if merging section 123 is determined at step S105 described above, the determination of not immediately branching can be made. When the determination of no branching is made (S106: NO), the lateral deviation with respect to N-pole magnetic marker 10N on main road 110 is acquired (S117), and steering control is performed by taking this lateral deviation as the controlled variable (S108). With this, vehicle 2 travels straight along main road 110 to pass through merging section 123.

For example, when branching section 121 is determined at step S105 described above and the above-described second traveling route (traveling route via side road 120) is set in vehicle 2, branching can be determined at step S106. When vehicle 2 branches (S106: YES), the lateral deviation with respect to S-pole magnetic marker 10S is acquired among two lateral deviations with respect to two magnetic markers 10 with different magnetic polarities simultaneously detected at step S103 described above (S107). As described above, S-pole magnetic marker 10S is laid on side road 120. With this, branching control for vehicle 2 to branch to side road 120 starts (S108).

In the following, the flow of control is described for each traveling pattern.

(Traveling Pattern of Passing Through the Branching Section without Branching)

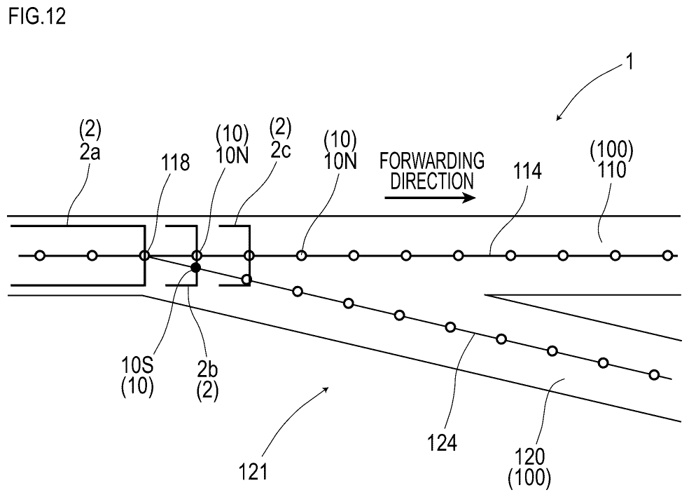

When vehicle 2 traveling main road 110 approaches branching section 121 and arrives at branching point 118 between marker array line 114 on main road 110 and marker array line 124 on side road 120 (sign 2a in FIG. 12), simultaneous detection of two magnetic markers 10 with different magnetic polarities next occurs (sign 2b in FIG. 12).

When the traveling route set in vehicle 2 is the above-described first traveling route not via side road 120, control unit 20 performs steering control by taking the lateral deviation with respect to N-pole magnetic marker 10N on main road 110 as the controlled variable. When vehicle 2 further proceeds (sign 2c in FIG. 12) and simultaneous detection of two magnetic markers 10 occurs irrespective of the combination of magnetic polarities, steering control by taking the lateral deviation with respect to N-pole magnetic marker 10N on main road 110 as the controlled variable continues. With this, vehicle 2 is steered so as to travel main road 110 without entering side road 120.

Note that in the laying mode of FIG. 5 of the present embodiment, only one laying point of laterally-aligned two magnetic markers 10 with different magnetic polarities is provided in branching section 121. In place of this, a plurality of laying points of laterally-aligned two magnetic markers 10 with different magnetic polarities may be provided in branching section 121. In this case, simultaneous detection of two magnetic markers 10 with different magnetic polarities continuously occurs. In this case, steering control is performed by taking the lateral deviation with respect to N-pole magnetic marker 10N on main road 110 as the controlled variable.

When vehicle 2 passes through branching point 118 to further travel, simultaneous detection of two magnetic markers 10 with same magnetic polarities occurs once or a plurality of times (sign 2c in FIG. 12). Among the lateral deviations of these two magnetic markers 10, control unit 20 selects the lateral deviation with the smaller difference from the controlled variable at the time of the immediately-previous magnetic marker detection (the controlled variable is the lateral deviation applied to the previous steering control). With this, as with the previous steering control, magnetic marker 10N on main road 110 is selected as the target to be followed, and vehicle 2 travels straight along main road 110.

### (Branching Traveling Pattern)

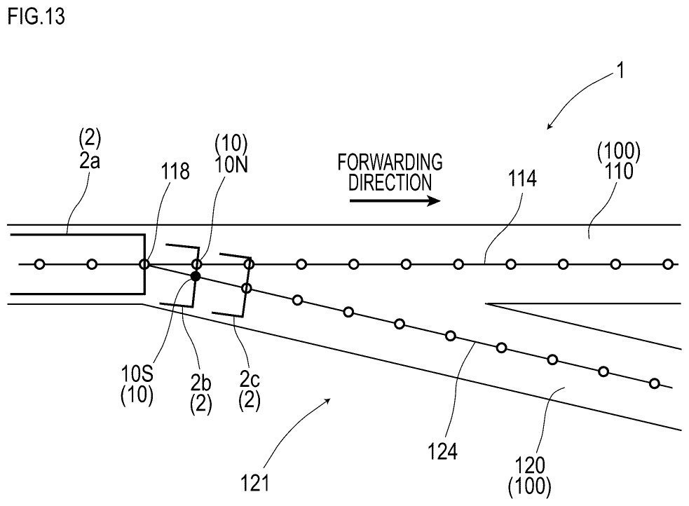

When vehicle 2 traveling main road 110 approaches branching section 121 and arrives at branching point 118 between marker array line 114 on main road 110 and marker array line 124 on side road 120 (sign 2a in FIG. 13), simultaneous detection of two magnetic markers 10 with different magnetic polarities occurs next (sign 2b in FIG. 13).

When the traveling route set in vehicle 2 is the above-described second traveling route via side road 120, control unit 20 performs steering control by taking the lateral deviation with respect to S-pole magnetic marker 10S on side road 120 as the controlled variable. With this, vehicle 2 is steered so as to branch from main road 110 to enter side road 120 (branching control).

Note that, in place of the laying mode of FIG. 5 of the present embodiment, a plurality of laying points of laterally-aligned two magnetic markers 10 with different magnetic polarities may be provided in branching section 121. In this case, simultaneous detection of two magnetic markers 10 with different magnetic polarities continuously occurs. In this case, steering control is performed by taking the lateral deviation with respect to S-pole magnetic marker 10S on side road 120 as the controlled variable. Vehicle 2 is steered so as to follow S-pole magnetic markers 10S on side road 120.

When vehicle 2 passes through branching point 118 to further travel, simultaneous detection of two magnetic markers 10 with same magnetic polarities occurs once or a plurality of times (sign 2c in FIG. 13). Among the lateral deviations with respect to these two magnetic markers 10, control unit 20 selects a lateral deviation with the smaller difference from the controlled variable at the time of the immediately-previous magnetic marker detection (the controlled variable is the lateral deviation applied to the previous steering control). With this, magnetic marker 10N on side road 120 is selected as the target to be followed, and vehicle 2 is steered so as to directly enter side road 120.

(Traveling Pattern in which the Vehicle on the Main Road Passes Through the Merging Section)

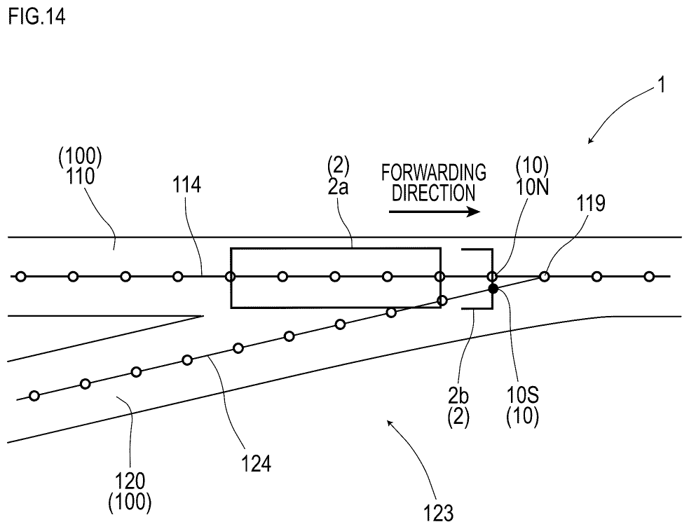

When vehicle 2 traveling main road 110 approaches merging section 123 and approaches merging point 119 between marker array line 114 on main road 110 and marker array line 124 on side road 120 (sign 2a in FIG. 14), simultaneous detection of two magnetic markers 10 with same magnetic polarities first occurs.

Among the lateral deviations with respect to these two magnetic markers 10 simultaneously detected, control unit 20 selects the lateral deviation with the smaller difference from the controlled variable at the time of the immediately-previous magnetic marker detection (the controlled variable is the lateral deviation applied to the previous steering control). With this, as with the previous steering control, magnetic marker 10N on main road 110 is selected as the target to be followed, and vehicle 2 is steered so as to travel straight along main road 110. In this manner, during a time when simultaneous detection of two magnetic markers 10 with same magnetic polarities occurs once or a plurality of times, vehicle 2 travels straight along main road 110.

When vehicle 2 further approaches merging point 119 (sign 2b in FIG. 14), simultaneous detection of two magnetic markers 10 with different magnetic polarities occurs. Control unit 20 refers to the traveling route set in vehicle 2 in response to the occurrence of simultaneous detection of two magnetic markers 10 with different magnetic polarities. When the traveling route set in vehicle 2 is the above-described first traveling route not via side road 120, control unit 20 performs steering control by taking the lateral deviation with respect to N-pole magnetic marker 10N on main road 110 as the controlled variable. With this, vehicle 2 is steered so as to travel straight on main road 110 to pass through merging section 123.

Note that in the laying mode of FIG. 6 of the present embodiment, only one laying point of laterally-aligned two magnetic markers 10 with different magnetic polarities is provided in merging section 123. In place of this, a plurality of laying points of laterally-aligned two magnetic markers 10 with different magnetic polarities may be provided in merging section 123. In this case, simultaneous detection of two magnetic markers 10 with different magnetic polarities continuously occurs. In this case, steering control is performed by taking the lateral deviation with respect to N-pole magnetic marker 10N on main road 110 as the controlled variable. Vehicle 2 is steered so as to follow N-pole magnetic marker 10N on main road 110.

(Traveling Pattern in which the Vehicle on the Side Road Merges to the Main Road)

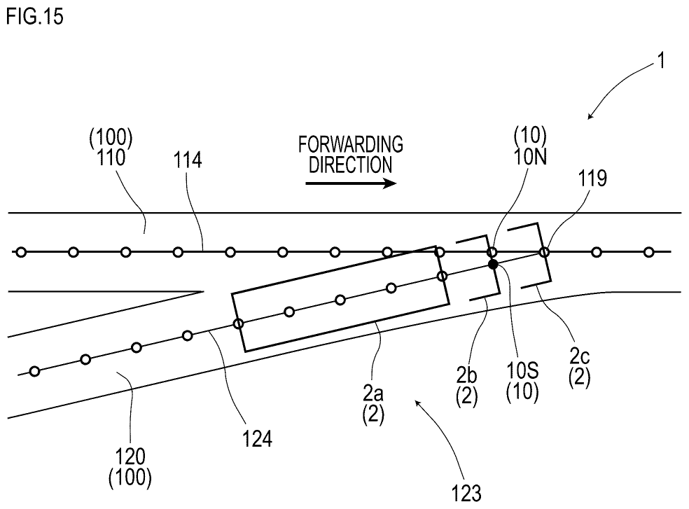

When vehicle 2 traveling side road 120 approaches merging section 123 and approaches merging point 119 between marker array line 114 on main road 110 and marker array line 124 on side road 120 (sign 2a in FIG. 15), simultaneous detection of two magnetic markers 10 with same magnetic polarities first occurs.

Among the lateral deviations with respect to these two magnetic markers 10 simultaneously detected, control unit 20 selects the lateral deviation with the smaller difference from the controlled variable at the time of the immediately-previous magnetic marker detection (the controlled variable is the lateral deviation applied to the previous steering control). With this, as with the previous steering control, magnetic marker 10N on side road 120 is selected as the target to be followed, and vehicle 2 is steered so as to travel along side road 120. In this manner, during a time when simultaneous detection of two magnetic markers 10 with same magnetic polarities occurs once or a plurality of times, vehicle 2 is steered so as to travel straight along side road 120.

When vehicle 2 further approaches merging point 119 (sign 2b in FIG. 15), simultaneous detection of two magnetic markers 10 with different magnetic polarities occurs. Control unit 20 determines that the vehicle has arrived at merging section 123 via side road 120, and starts merging control by switching the target to be followed to N-pole magnetic marker 10N on main road 110.

Note that, in place of the laying mode of FIG. 6 of the present embodiment, a plurality of laying points of laterally-aligned two magnetic markers 10 with different magnetic polarities may be provided in merging section 123. In this case, simultaneous detection of two magnetic markers 10 with different magnetic polarities continuously occurs. In this case, steering control is performed by taking the lateral deviation with respect to N-pole magnetic marker 10N on main road 110 as the controlled variable. Vehicle 2 is steered so as to follow N-pole magnetic marker 10N on main road 110.

When vehicle 2 arrives at merging point 119 (sign 2c in FIG. 15), simultaneous detection of two magnetic markers 10 ends, and only one magnetic marker 10 on main road 110 is detected. Control unit 20 performs steering control by taking the lateral deviation with respect to this magnetic marker 10 as the controlled variable. With this, vehicle 2 can follow and travel main road 110.

As described above, marker system 1 of the present embodiment has a technical feature in the combination of magnetic polarities of laterally-aligned two magnetic markers 10 laid on different paths of the plurality of paths. In laterally-aligned two magnetic markers 10, the combination of magnetic polarities varies in accordance with whether a distance between the two magnetic markers 10 is equal to or shorter than the predetermined threshold value. While the combination of the magnetic polarities is a combination of different magnetic polarities when the distance between the two magnetic markers 10 is equal to or shorter than the predetermined threshold value, the combination of the magnetic polarities is a combination of same magnetic polarities when the distance between the two magnetic markers 10 exceeds the predetermined threshold value. Note, in laterally-aligned two magnetic markers 10, the combination of magnetic polarities may varies in accordance with whether the distance between the two magnetic markers 10 is below the predetermined threshold value or not.

As laterally-aligned two magnetic markers 10 approach closer to each other, the possibility of occurrence of magnetic interference increases. If the magnetic polarities of these two magnetic markers 10 are the same, the magnetic distribution becomes broad due to magnetic interference acted from two magnetic markers 10, and a possibility occurs in which the peak supposed to appear directly above magnetic marker 10 is difficult to detect. On the other hand, if the magnetic polarities of laterally-aligned two magnetic markers 10 are different, detection of the peak in the magnetic distribution is easy even if magnetic interference occurs, and each magnetic marker 10 can be detected with high reliability.

The control method of the present embodiment is the control method of causing vehicle 2 to enter side road 120 (one example of a path) branching from the path forming main road 110 with an impetus of simultaneous detection of two magnetic markers 10 with different magnetic polarities when vehicle 2 is branched from the path forming main road 110. Also, the control method of the present embodiment is the control method of causing vehicle 2 to enter the path forming main road 110 from side road 120 with the impetus of simultaneous detection of two magnetic markers 10 with different magnetic polarities when vehicle 2 is merged to the path forming main road 110.

In the configuration of the present embodiment, N-pole magnetic markers 10N are laid on traveling road 100 except for branching section 121 and merging section 123. Thus, S-pole magnetic marker 10S laid on branching section 121 or merging section 123 can serve as the impetus for starting branching control or merging control. By using S-pole magnetic marker 10S laid in branching section 121 and merging section 123 on side road 120, it is possible for control unit 20 to start branching control or merging control at extremely appropriate timing.

Magnetic markers 10 with different magnetic polarities laid in branching section 121 and merging section 123 indicate, with high accuracy, the position of a connecting point (branching point 118, merging point 119) between marker array line 114 on main road 110 and marker array line 124 on side road 120. On the vehicle 2 side, by detecting magnetic markers 10 with different magnetic polarities, it is possible to grasp, without delay, arrival at the connecting point between marker array line 114 on main road 110 and marker array line 124 on side road 120 and perform branching control or merging control at almost optimal timing.

### Second Embodiment

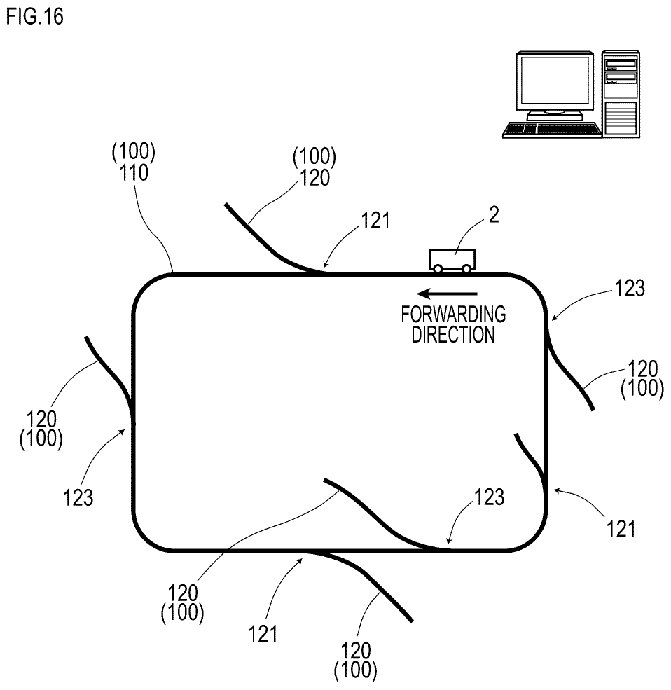

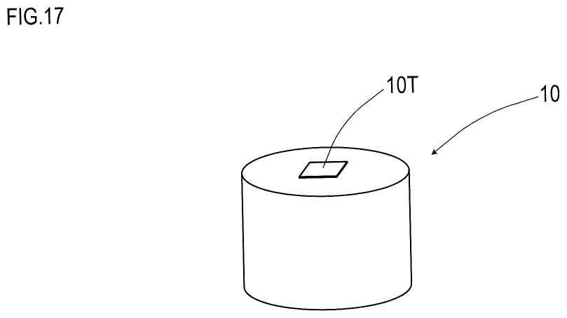

The present embodiment is an example of marker system 1 based on the marker system of the first embodiment and is applied to traveling road 100 with a complex path structure. Details of this are described with reference to FIG. 16 and FIG. 17.

Traveling road 100 (FIG. 16) of the present embodiment is a traveling road where a plurality of branching sections 121 and merging sections 123 are set. Marker system 1 applied to this traveling road 100 is configured to include a server device that can be accessed by vehicle 2 via wireless communication.

In the server device, a database having attribute information of at least specific magnetic marker 10 recorded thereon is constructed. Specific magnetic marker 10 is a magnetic marker with a magnetic polarity different from laterally-aligned magnetic marker 10 in branching section 121 and merging section 123. In the database, attribute information of the corresponding magnetic marker 10 is recorded as having identification information of magnetic marker 10 linked thereto. The attribute information is, for example, information indicating the kind such as branching section 121, merging section 123, or the like, information indicating the position of branching section 121 or merging section 123, or the like. By referring to the database by using the identification information of magnetic markers 10, it is possible to identify branching section 121 or merging section 123.

Any of two magnetic markers 10 with different magnetic polarities laterally aligned is specific magnetic marker 10 described above. At least either one of these two magnetic markers 10 is a magnetic marker with RFID tag 10T affixed to an end face (FIG. 17). Tag information to be outputted from RFID tag 10T is information that can uniquely identify corresponding magnetic marker 10, and can be used as identification information of that magnetic marker 10.

Vehicle 2 of the present embodiment includes, although not depicted in the drawings, a tag reader for reading the tag information from RFID tag 10T and a wireless communication circuit for accessing the database of the server device. Furthermore, vehicle 2 includes a storage device that stores information about a path set in advance. The information about the path includes information for specifying branching section 121 to be passed through, branching section 121 to be branched, merging section 123 to be passed through, and merging section 123 to be merged.

When arriving at branching section 121 or merging section 123, vehicle 2 reads tag information from RFID tag 10T attached to the above-described specific magnetic marker 10. By using this tag information, which is identification information of magnetic marker 10, vehicle 2 accesses the server device and acquires attribute information to which this tag information (identification information) is linked. As described above, this attribute information is, for example, information indicating the kind such as branching section 121, merging section 123, or the like, information indicating the position of branching section 121 or merging section 123, or the like.

Vehicle 2 determines, based on information about the traveling route set in advance, whether to branch or merge in branching section 121 or merging section 123 where magnetic marker 10 corresponding to the acquired attribute information is located. In vehicle 2, in accordance with the determination result, branching control or merging control is performed as appropriate.

Note that other configurations and operations and effects are similar to those in the first embodiment.

### Third Embodiment

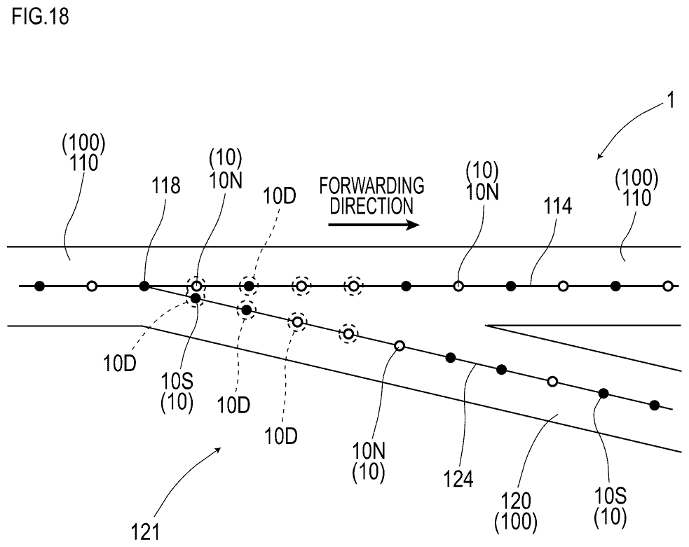

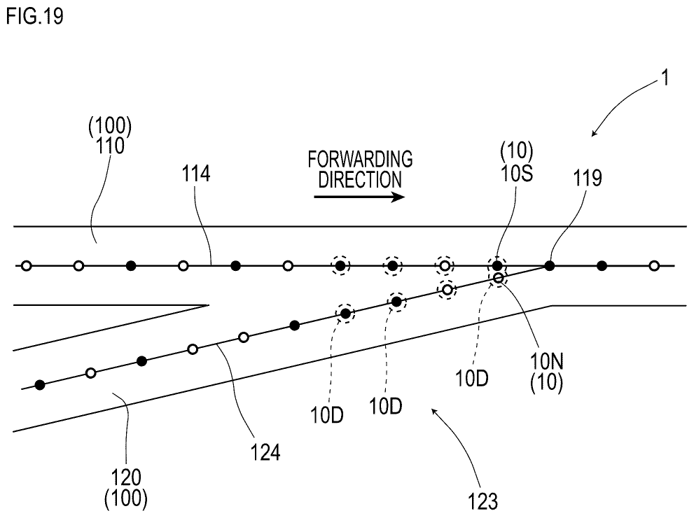

The present embodiment is based on the marker system of the first embodiment, and is an embodiment in which polarities of magnetic markers 10 laid in traveling road 100 are changed. Details of this are described with reference to FIG. 18 to FIG. 20. In marker system 1 of the present embodiment, the magnetic polarities of magnetic markers 10 are random except for those at part of marker laying positions 10D (FIG. 18 and FIG. 19) belonging to branching section 121 and merging section 123.

Part of marker laying positions 10D are laying positions of magnetic markers 10 with a possibility of being detected simultaneously with any of other laterally-aligned magnetic markers 10. In the present embodiment, the laying position of magnetic marker 10 with a space with other laterally-aligned magnetic marker 10 being equal to or shorter than 2.3 meters, which is the width of vehicle 2, is specified as marker laying position 10D. Marker laying position 10D is a position where the magnetic polarity of laid magnetic marker 10 is controlled.

Furthermore, among marker laying positions 10D, marker laying position 10D with the space with other laterally-aligned marker laying position 10D being equal to or shorter than 0.3 meters is a position where magnetic marker 10 with a magnetic polarity different from that of other laterally-aligned magnetic marker 10 is to be laid. Note that any of magnetic markers 10 laid on main road 110 and side road 120 is not required to be specified as having the N pole or the S pole. It is only required that the magnetic polarities of laterally-aligned these two magnetic markers 10 be different.

Among marker laying positions 10D, marker laying position 10D with the space with other laterally-aligned marker laying position 10D being longer than 0.3 meters and equal to or shorter than 2.3 meters is a position where magnetic marker 10 with the same magnetic polarity as that of other laterally-aligned magnetic marker 10 is to be laid. Note that the magnetic polarities of laterally-aligned these two magnetic markers 10 are any and it is only required that the magnetic polarities of these two magnetic markers 10 be the same.

In FIG. 18 exemplarily depicting branching section 121, marker laying position 10D on main road 110 and marker laying position 10D on side road 120 immediately after passage through branching point 118 are positions each at which magnetic marker 10 with the magnetic polarity different from that of laterally-aligned magnetic marker 10 is to be laid. Second to fourth marker laying positions 10D on main road 110 and second to fourth marker laying positions 10D on side road 120 after passage through branching point 118 are positions each at which magnetic marker 10 with the same magnetic polarity as that of other laterally-aligned magnetic marker 10 is to be laid.

In FIG. 19 exemplarily depicting merging section 123, marker laying position 10D on main road 110 and marker laying position 10D on side road 120 immediately before merging point 119 are positions each at which magnetic marker 10 with the magnetic polarity different from that of other laterally-aligned magnetic marker 10 is to be laid. Second to fourth marker laying positions 10D on main road 110 and second to fourth marker laying positions 10D on side road 120 immediately before merging point 119 are positions each at which magnetic marker 10 with the same magnetic polarity as that of other laterally-aligned magnetic marker 10 is to be laid.

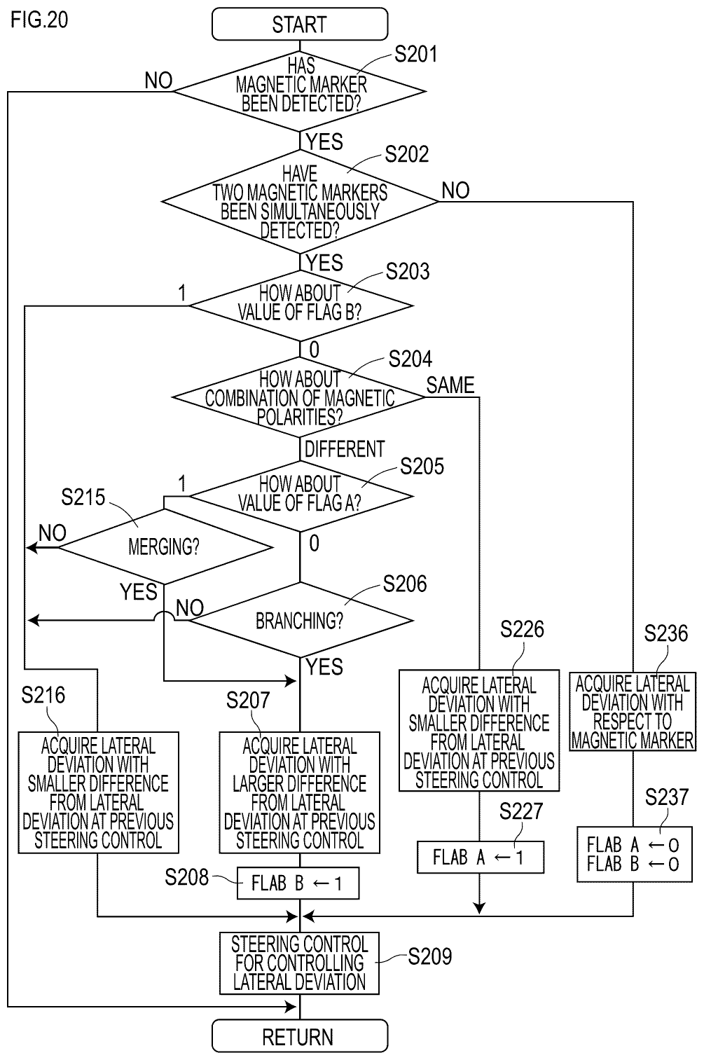

The control by marker system 1 of the present embodiment is described with reference to a flow diagram of FIG. 20. When acquiring the process result indicating that magnetic marker 10 has been detected (S201: YES), control unit 20 first determines whether two magnetic markers 10 have been simultaneously detected (S202). In the case of not simultaneous detection of two magnetic markers 10 but single detection of one magnetic marker 10 (S202: NO), control unit 20 acquires the lateral deviation with respect to magnetic marker 10 from the process result of the marker detection process (S236). Vehicle 2 travels by steering control by taking the lateral deviation acquired as described above as the controlled variable (S209).

In this manner, control of vehicle 2 traveling main road 110 or side road 120 other than branching section 121 and merging section 123 is exactly identical to that of the first embodiment. However, in the process of the present embodiment, step S237 of resetting flag A and flag B to zero is added subsequently to step S236 described above.

Flag A is a control flag indicating an occurrence of simultaneous detection of two magnetic markers 10 with same magnetic polarities. In the configuration of the present embodiment, when two magnetic markers 10 with different magnetic polarities are simultaneously detected, flag A is used to determine whether these two magnetic markers 10 are in branching section 121 or merging section 123. Flag B is a control flag indicating that branching control or merging control has started. Flags A and B are reset to zero after passage through branching section 121 or merging section 123. Before vehicle 2 enters branching section 121 or merging section 123, flags A and B are both in a state of being reset to zero.

When two magnetic markers 10 have been simultaneously detected (S202: YES), the value of flag B indicating that branching control or merging control has started is first determined (S203). When flag B indicates 1, that is, if branching control or merging control has started (S203: 1), step S216 is performed. At this step S216, among two lateral deviations with respect to two magnetic markers 10 simultaneously detected, the lateral deviation with the smaller difference from the controlled variable at the time of the immediately-previous magnetic marker detection (the controlled variable is the lateral deviation applied to the previous steering control) is acquired. The process at step S216 is performed irrespective of the combination of magnetic polarities of two magnetic markers 10 simultaneously detected. Then, vehicle 2 is subjected to steering control by taking the lateral deviation acquired as described above as the controlled variable (S209).

On the other hand, when flag B indicates zero at step S203, that is, if neither branching control nor merging control has not started (S203: 0), the combination of magnetic polarities of two magnetic markers 10 simultaneously detected is determined (S204). When the magnetic polarities of two magnetic markers 10 simultaneously detected are the same (S202: YES→S203: 0→S204: same), step S226 is performed. At this step S226, among two lateral deviations with respect to two magnetic markers 10 simultaneously detected, the lateral deviation with the smaller difference from the controlled variable at the time of the immediately-previous magnetic marker detection (the controlled variable is the lateral deviation applied to the previous steering control) is acquired.

The process at step S226 is identical to the above-described process at step S216. However, step S227 of substituting 1 for flag A comes subsequently to step S226. After 1 is substituted for flag A (S227), vehicle 2 is subjected to steering control by taking the lateral deviation acquired at step S226 as the controlled variable (S209).

On the other hand, when the magnetic polarities of two magnetic markers 10 simultaneously detected before the start of branching control and merging control are different (S202: YES→S203: 0→S204: different), control unit 20 first determines the value of flag A (S205). Flag A indicates whether simultaneous detection of two magnetic markers 10 with same magnetic polarities has occurred in advance. If simultaneous detection of two magnetic markers 10 with same magnetic polarities has occurred in advance, that is, at the time of entering merging section 123, 1 has been substituted for flag A at step S227 described above. On the other hand, at the time of entering branching section 121, prior to simultaneous detection of two magnetic markers 10 with different magnetic polarities, no simultaneous detection of two magnetic markers 10 with same magnetic polarities occurs, and therefore flag A stays at zero.

Therefore, when flag A indicates zero (S205: 0), entering not merging section 123 but branching section 121 can be determined. In response to entering branching section 121, control unit 20 makes a determination as to whether to branch (S206). When the second traveling route (traveling route via side road 120) is set in vehicle 2, control unit 20 determines to branch.

When the traveling route of vehicle 2 is to branch (S206: YES), control unit 20 starts branching control by performing replacement of magnetic marker 10 as the target to be followed at step S207. At step S207, from two lateral deviations with respect to two magnetic markers 10 simultaneously detected, the lateral deviation with a larger difference from the controlled variable at the time of the immediately-previous magnetic marker detection (the controlled variable is the lateral deviation applied to the previous steering control) is acquired. With this, magnetic marker 10 as the target to be followed is replaced from magnetic marker 10 on main road 110 to magnetic marker 10 on side road 120. Then, in response to this replacement of magnetic marker 10 as the target to be followed, branching control is started, and 1 is substituted for flag B (step S208).

When this branching control is started and then simultaneous detection of two magnetic markers 10 with different magnetic polarities occurs, since flag B indicates 1, step S207 described above is not performed again. In this case, based on the determination at step S203, step S216 described above is immediately performed. At this step S216, among two lateral deviations with respect to two magnetic markers 10 simultaneously detected, the lateral deviation with the smaller difference from the controlled variable at the time of the immediately-previous magnetic marker detection (the controlled variable is the lateral deviation acquired at the previous step S207 and applied to steering control) is acquired. That is, magnetic marker 10 on side road 120 set as the target to be followed in response to the start of branching control at the previous step S207 is maintained as it is as the target to be followed.

When no branching is determined at step S206 described above (S206: NO), the process proceeds to step S216, at which, among two lateral deviations with respect to two magnetic markers 10 simultaneously detected, the lateral deviation with the smaller difference from the controlled variable at the time of the immediately-previous magnetic marker detection (the controlled variable is the lateral deviation acquired at the previous step S207 and applied to steering control) is acquired. That is, magnetic marker 10 on main road 110 is maintained as it is as the target to be followed.

If the vehicle passes through branching section 121, simultaneous detection of magnetic markers 10 with same magnetic polarities occurs (S201→S202: YES). In this case, branching control is not started, and therefore flag B indicates zero. In the case of simultaneous detection of two magnetic markers 10 with same magnetic polarities (S204: same), the process proceeds to step S226, at which a state of following magnetic markers 10 on main road 110 is maintained. Then, at the subsequent step S227, 1 is substituted for flag A. In branching section 121, marker array line 114 on main road 110 and marker array line 124 on side road 120 form a V shape. Therefore, after step S227 is performed and during passage through branching section 121, simultaneous detection of two magnetic markers 10 with different magnetic polarities does not occur, and processes following “step S204: different” are not performed. Therefore, vehicle 2 travels along main road 110 and can pass through branching section 121.

On the other hand, at step S205 to be performed in response to simultaneous detection of two magnetic markers 10 with different magnetic polarities prior to the start of branching control and merging control, when flag A indicates 1, that is, in the case of entering merging section 123 (S205: 1), control unit 20 determines whether to merge at step S215. When the second traveling route is set in vehicle 2, control unit 20 determines as merging.

When the traveling route of vehicle 2 requires merging (S215: YES), control unit 20 performs replacement of magnetic marker 10 as the target to be followed at step S207, thereby starting merging control. Specifically, among two lateral deviations with respect to two magnetic markers with different magnetic polarities simultaneously detected, the lateral deviation with the larger difference from the controlled variable at the time of the immediately-previous magnetic marker detection (the controlled variable is the lateral deviation applied to the previous steering control) is acquired. With this, magnetic marker 10 as the target to be followed is replaced from magnetic marker 10 on side road 120 to magnetic marker 10 on main road 110. Then, merging control is started in response to replacement of magnetic marker 10 as the target to be followed, and 1 is substituted for flag B (S208).

If this merging control is started and then simultaneous detection of two magnetic markers 10 with different magnetic polarities occurs, since flag B indicates 1, step S207 described above is not performed again. In this case, based on the determination at step S203, step S216 described above is immediately performed. At this step S216, among two lateral deviations with respect to two magnetic markers 10 simultaneously detected, the lateral deviation with the smaller difference from the controlled variable at the time of the immediately-previous magnetic marker detection (the controlled variable is the lateral deviation acquired at the previous step S207 and applied to steering control) is acquired. That is, magnetic marker 10 on main road 110 set as the target to be followed in response to the start of merging control at the previous step S207 is maintained as it is as the target to be followed.

On the other hand, no merging is determined at step S215 described above (S215: NO), among two lateral deviations with respect to two magnetic markers 10 with different magnetic polarities simultaneously detected, the lateral deviation with the smaller difference from the controlled variable at the time of the immediately-previous magnetic marker detection (the controlled variable is the lateral deviation applied to the previous steering control) is acquired (S216), and steering control is performed (S208). That is, the state of vehicle 2 traveling along main road 110 is maintained as it is.

Note that other configurations and operations and effects are similar to those in the first embodiment.

In the foregoing, while specific examples of the present invention are described in detail as in the embodiments, these specific examples merely disclose examples of technology included in the scope of the claims. Needless to say, the scope of the claims should not be restrictively construed based on the configuration, numerical values, and so forth of the specific examples. The scope of the claims includes technologies acquired by variously modifying, changing, or combining as appropriate the above-described specific examples by using known technologies, knowledge of a person skilled in the art, and so forth.

1. A marker system comprising a plurality of magnetic markers arranged as spaced along a plurality of paths where a vehicle travels, wherein
in a combination of two magnetic markers of the plurality of magnetic markers laid on different paths of the plurality of paths and adjacent to each other in a lateral direction orthogonal to a path direction, a combination of magnetic polarities of the two magnetic markers varies in accordance with a distance between the two magnetic markers, and
i) while the combination of the magnetic polarities of the two magnetic markers is a combination of different magnetic polarities when the distance between the two magnetic markers is equal to or shorter than the predetermined threshold value, the combination of the magnetic polarities of the two magnetic markers is a combination of same magnetic polarities when the distance between the two magnetic markers exceeds the predetermined threshold value, or
ii) while the combination of the magnetic polarities of the two magnetic markers is the combination of different magnetic polarities when the distance between the two magnetic markers is below the predetermined threshold value, the combination of the magnetic polarities of the two magnetic markers is the combination of same magnetic polarities when the distance between the two magnetic markers is equal to or longer than the predetermined value.

2. The marker system in claim 1, further comprising a database recording attribute information of the plurality of magnetic markers laid on the plurality of paths, wherein
the combination of the two magnetic markers includes a combination of a magnetic marker laid on a path forming a main road and a magnetic marker laid on a path branching from the path forming the main road, the combination of the two magnetic markers with a spaced distance therebetween being equal to or shorter than the predetermined threshold value or below the predetermined threshold value, and
in the database, at least one of the two magnetic markers has the attribute information indicating a branching section recorded thereon.

3. The marker system in claim 1, further comprising a database recording attribute information of the plurality of magnetic markers laid on the plurality of paths, wherein
the combination of the two magnetic markers includes a combination of a magnetic marker laid on a path forming a main road and a magnetic marker laid on a path merging to the path forming the main road, the combination of the two magnetic markers with a spaced distance therebetween being equal to or shorter than the predetermined threshold value or below the predetermined threshold value, and
in the database, at least one of the two magnetic markers has the attribute information indicating a merging section recorded thereon.

4. A control method for causing a vehicle to travel along a plurality of paths by using the marker system in claim 2, the vehicle including a magnetic detection area elongated in a vehicle-width direction and a magnetic detection circuit simultaneously detecting the two magnetic markers adjacent to each other in the lateral direction, the method comprising:
when the vehicle is caused to branch from the path forming the main road, starting control of causing the vehicle to enter a path branching from the path forming the main road with simultaneous detection of the two magnetic markers with different magnetic polarities as a trigger.

5. The control method in claim 4, further comprising, every time any of the plurality of magnetic markers is detected, controlling steering by taking a lateral deviation of the vehicle with respect to the detected magnetic marker as a controlled variable,
when the vehicle is caused to branch from the path forming the main road and the simultaneous detection of the two magnetic markers with different magnetic polarities occurs, the controlling steering is performed in which, from two lateral deviations with respect to the two magnetic markers, a lateral deviation with a larger difference from a lateral deviation as a controlled variable at immediately-previous magnetic marker detection is taken as the controlled variable, thereby starting the control of causing the vehicle to enter the path branching from the path forming the main road, and
after starting the control, when the simultaneous detection of the two magnetic markers occurs irrespective of whether the magnetic polarities are same or different, the controlling steering is performed in which a lateral deviation with a smaller difference from the lateral deviation as the controlled variable at the immediately-previous magnetic marker detection is taken as the controlled variable.

6. A control method for causing a vehicle to travel along a plurality of paths by using the marker system in claim 1, the combination of the two magnetic markers including a combination of a magnetic marker laid on a path forming a main road and a magnetic marker laid on a path merging to the path forming the main road, the combination of the two magnetic markers with a spaced distance therebetween being equal to or shorter than the predetermined threshold value or below the predetermined threshold value, and the vehicle including a magnetic detection area elongated in a vehicle-width direction and a magnetic detection circuit simultaneously detecting the two magnetic markers adjacent to each other in the lateral direction, the method comprising:
when the vehicle is caused to merge from the merging path to the path forming the main road, starting control of causing the vehicle to merge from the path merging to the path forming the main road with simultaneous detection of the two magnetic markers with different magnetic polarities as a trigger.

7. The control method in claim 6, further comprising, every time any of the plurality of magnetic markers is detected, controlling steering by taking a lateral deviation of the vehicle with respect to the detected magnetic marker as a controlled variable,
when the vehicle is caused to merge from the path merging to the path forming the main road and the simultaneous detection of the two magnetic markers with different magnetic polarities occurs, the controlling steering is performed in which, from two lateral deviations with respect to the two magnetic markers, a lateral deviation with a larger difference from a lateral deviation as a controlled variable at immediately-previous magnetic marker detection is taken as the controlled variable, thereby starting the control of causing the vehicle to merge from the path merging to the path forming the main road, and
after starting the control, when the simultaneous detection of the two magnetic markers occurs irrespective of whether the magnetic polarities are same or different, the controlling steering is performed in which a lateral deviation with a smaller difference from the lateral deviation as the controlled variable at the immediately-previous magnetic marker detection is taken as the controlled variable.
